(19) United States
(12) Patent Application Publication
(10) Pub. No.: US 2006/0236116 A1
(43) Pub. Date: Oct. 19, 2006

(54) Provisioning root keys

(75) Inventor: Sarvar Patel, Montville, NJ (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/108,609

(22) Filed: Apr. 18, 2005

(51) Int. Cl. H04L 9/00

(52) U.S. Cl. 713/183

(57) ABSTRACT

The present invention provides a method of key material generation for authenticating communication with at least one network application function. The method includes determining first key material in response to a bootstrapping key request and determining second key material in response to determining the first key material. The second key material corresponds to third key material, which is determined and provided to the at least one network application function in response to determining the first key material.

### BACKGROUND OF THE INVENTION

1. Field of the Invention

This invention relates generally to communication systems, and, more particularly, to wireless communication systems.

2. Description of the Related Art

Conventional wireless communication systems use various authentication techniques to protect the security and/or integrity of information transmitted through the system. For example, an Authentication and Key Agreement (AKA) protocol has been implemented in the Third Generation Partnership Project (3GPP) authentication infrastructure. The 3GPP AKA protocol may be leveraged to enable application functions in the network and/or on the user side to establish shared keys using a bootstrapping technique.

FIG. 1 conceptually illustrates a conventional model of a bootstrapping architecture 100 that is based on the 3GPP AKA protocol. The bootstrapping architecture 100 includes a Home Subscriber Server (HSS) that is coupled to a Bootstrapping Server Function (BSF) by an interface Zh. The BSF is coupled to one or more User Equipment (UE, also commonly referred to as mobile units) by an interface Ub. The BSF is also connected to a Network Application Function (NAF) by an interface Zn. The NAF is coupled to the UE by an interface Ua. The entities included in the bootstrapping architecture 100 are described in detail in the 3GPP Technical Specification 3GPP TS 33.220 V6.3.0 (2004-12), which is hereby incorporated herein by reference in its entirety.

FIG. 2 conceptually illustrates a conventional bootstrapping procedure 200. The UE may initiate the bootstrapping procedure 200 by sending a request towards the BSF, as indicated by arrow 205. The BSF may retrieve user security settings and/or authentication data, such as an Authentication Vector, from the HSS, as indicated by double arrow 210. The BSF sends an authentication request (indicated by the arrow 215) to the UE. The authentication request 215 may be formed based upon the user security settings and/or authentication data retrieved from the HSS. The authentication request 215 may include random numbers and/or authentication tokens that may be used in the authentication process. The UE performs (at 220) Authentication and Key Agreement procedures to verify that the authentication request is from an authorized network. The UE may also calculate various session keys and/or a digest AKA response.

The digest AKA response is sent to the BSF (as indicated by the arrow 225), which may authenticate (at 230) the UE based upon the digest AKA response. The BSF may then generate (at 230) one or more keys (Ks), as well as one or more lifetimes of the keys. A confirmation message including the keys and, if available, the key lifetimes may be sent to the UE, as indicated by the arrow 235. In response to receiving the confirmation message, the UE may generate (at 240) one or more keys (Ks), which should correspond to the one more keys (Ks) generated by the BSF. The UE and the BSF may use the keys (Ks) to generate key material Ks_NAF that may be used for communication between the UE and an NAF.

FIG. 3 conceptually illustrates a conventional method 300 of forming a secure communication link between a UE and an NAF. The UE derives (at 305) key material Ks_NAF using the key (Ks) and then transmits an application request to the NAF, as indicated by the arrow 310. The application request 310 typically includes a bootstrapping transaction identifier (B-TID), as well as other information. The NAF transmits an authentication request to the BSF, as indicated by the arrow 315. The authentication request 315 includes the B-TID and a NAF host name. The BSF provides an authentication answer, as indicated by the arrow 320. The authentication answer 320 typically includes key material Ks_NAF derived from the key (Ks), as well as any appropriate key lifetimes. The key material Ks_NAF is stored (at 325) by the NAF and an application answer is provided to the UE. Once the method 300 of forming the secure communication link is complete, the UE and the NAF may communicate securely through the interface Ua shown in FIG. 1.

Conventional bootstrapping procedures, such as the 3GPP GBA architecture described above, are not friendly to the provisioning of root keys needed by various services and technologies, especially root keys needed by existing services. For example, standards for root key provisioning may need to be changed to facilitate the exchange of information such as the BTID and various acknowledgments transmitted between the UE and NAF. New and/or existing services that were not designed to be compatible with bootstrapping procedures may not be able to establish root keys using their existing hardware and/or software. Moreover, modifying the hardware and/or software to accommodate bootstrap provisioning may result in undesirable changes to the software and/or libraries used by other applications.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for key material generation for authenticating communication with at least one network application function. The method may include determining first key material in response to a bootstrapping key request and determining second key material in response to determining the first key material. The second key material may correspond to third key material, which is determined and provided to the at least one network application function in response to determining the first key material.

In another embodiment of the present invention, a method is provided for key material generation for authenticating communication with at least one network application function. The method may include determining first key material in response to a bootstrapping key request and determining second key material in response to determining the first key material. The second key material corresponds to third key material, which is determined by user equipment in response to determining the first key material. The method may also include providing the second key material to the at least one network application function.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a conventional model of a bootstrapping architecture that is based on the 3GPP AKA protocol;

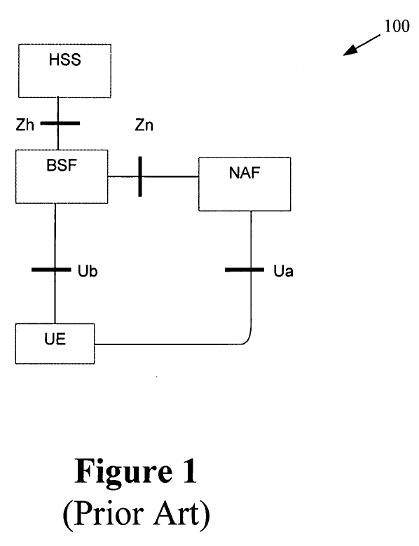

FIG. 2 conceptually illustrates a conventional bootstrapping procedure;

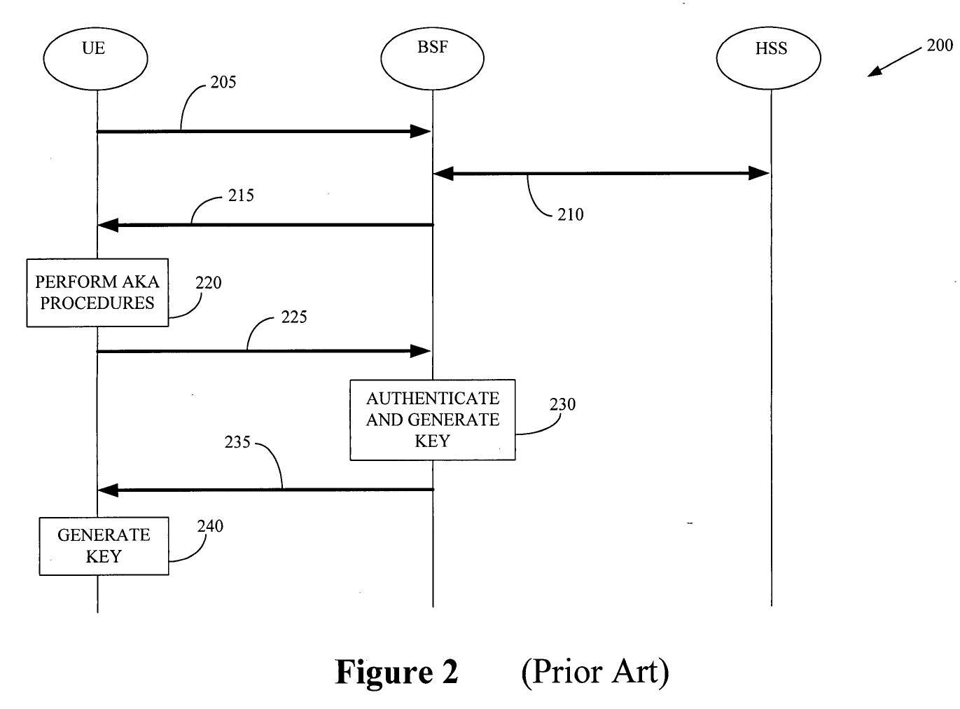

FIG. 3 conceptually illustrates a conventional method of forming a secure communication link between a UE and an NAF; and

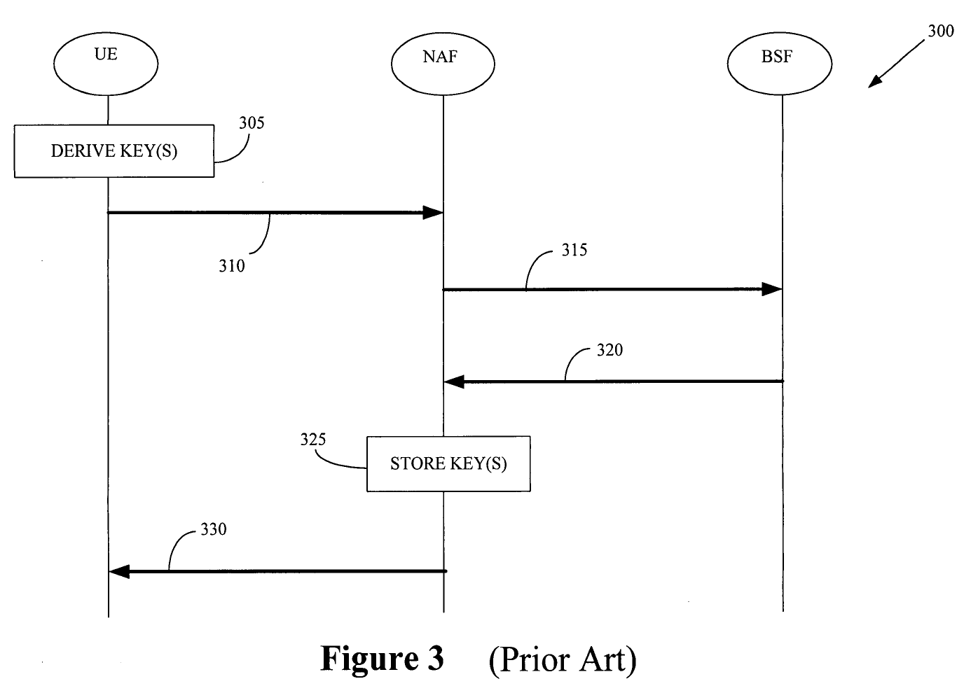

FIG. 4 conceptually illustrates one exemplary embodiment of a method of provisioning keys, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

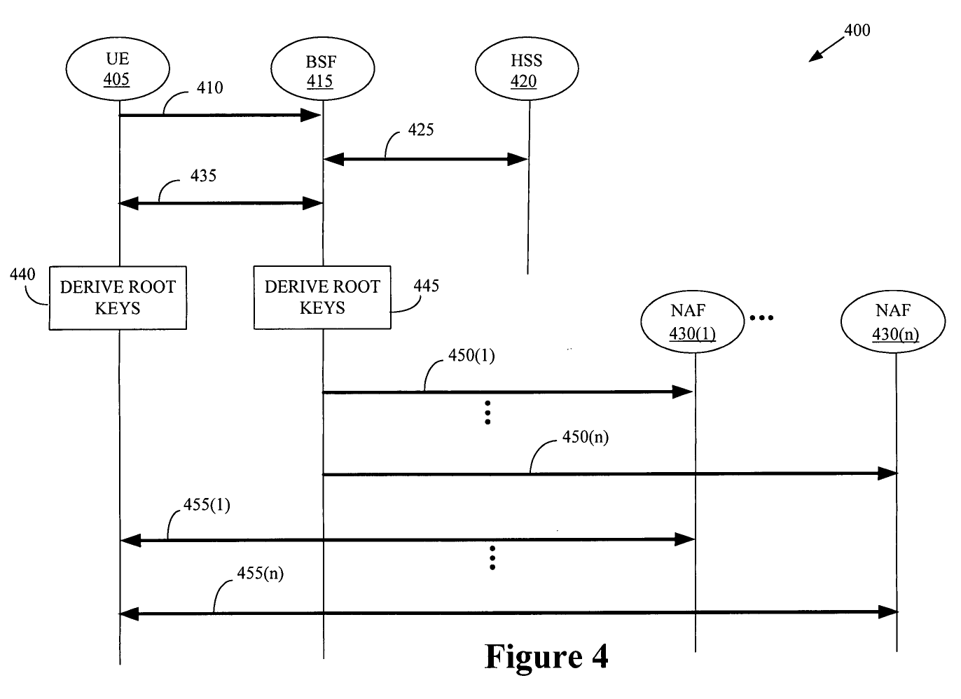

FIG. 4 conceptually illustrates one exemplary embodiment of a method 400 of provisioning keys. In the illustrated embodiment, user equipment (UE) 405 provides a bootstrapping request (indicated by the arrow 410). For example, the user equipment 405 may provide the bootstrapping request 410 to a bootstrapping server function 415. The user equipment 405, which may also be referred to as a mobile unit, may include cellular telephones, personal data assistants, smart phones, text messaging devices, laptop computers, and the like. The bootstrapping server function 415 retrieves bootstrapping information from a home subscription server (HSS) 420, as indicated by the arrow 425. In various alternative embodiments, the bootstrapping information may include an authentication vector, one or more key values, user security settings such as Generic Bootstrapping Architecture user security settings (GUSS), information indicative of one or more network application functions (NAF) 430(1-n), addresses of the network application functions 430(1-n), and the like. Persons of ordinary skill in the art should appreciate that in alternative embodiments other entities may provide all or a portion of the bootstrapping information. These entities may include a home location register, an Authentication Authorization and Accounting (AAA) server, and the like.

The user equipment 405 and the bootstrapping server function 415 mutually authenticate each other, as indicated by the arrow 435. In one embodiment, the user equipment 405 and the bootstrapping server function 415 mutually authenticate each other using a bootstrapping key generation process, such as the bootstrapping key generation process implemented in the Generic Bootstrapping Architecture described in the 3GPP Technical Specification 3GPP TS 33.220 V6.3.0 (2004-12). Key material is determined during the mutual authentication procedure 435. For example, the bootstrapping key generation process implemented in the Generic Bootstrapping Architecture may form key material (Ks) during the mutual authentication procedure 435.

The user equipment 405 and the bootstrapping server function 415 independently derive (at 440 and 445) key material (Ks_NAF1, . . . , Ks_NAFn) associated with the network application functions 430(1-n). In one embodiment, the key material (Ks_NAF1, . . . , Ks_NAFn) derived (at 440 and 445) by the user equipment 405 and the bootstrapping server function 415 is determined based upon the key material that was determined during the authentication process 435. The key material (Ks_NAF1, . . . , Ks_NAFn) may also be derived (at 440 and 445) in response to the mutual authentication (at 435) of the user equipment 405 and the bootstrapping server function 415. The key material (Ks_NAF1, . . . , Ks_NAFn) may be derived using an appropriate key derivation function. For example, the key material associated with the network application function 430(1) may be derived using the key derivation function KDF( ), e.g. Ks_NAF1=KDF(Ks, NAF1, other parameters), where NAF1 includes information indicative of the network application function 430(1).

In one embodiment, the key material derived (at 440 and 445) by the user equipment 405 and the bootstrapping server function 415 includes one or more root keys. As used herein, the term “root key” refers to a key that is common to at least the user equipment 405 and the network application functions 430(1-n). The root key may be used to derive other keys, such as session keys that may be used to establish secure communications sessions between the user equipment 405 and one or more of the network application functions 430(1-n). Root keys may be used to provide security for new services such as location services, existing services, and/or different access technologies like IEEE 802.11 technologies, Bluetooth technologies, network overlays like IP Multimedia Systems (IMS), and the like.

Root keys may be maintained over a relatively long period of time, e.g. many days, months, or years. For example, root keys associated with the user equipment 405 may remain unchanged during a subscription period associated with a user of the user equipment 405. However, persons of ordinary skill in the art should appreciate that root keys associated with the user equipment 405 may be changed or refreshed. For example, root keys stored by user equipment 405 that does not have non-volatile memory may be lost or erased when the user equipment 405 powers down, in which case a new root key may be determined. For another example, the key material determined during the mutual authentication procedure 435 may be changed and one or more new root keys may be formed in response to the change.

The key material (Ks_NAF1, . . . , Ks_NAFn) is then provided to the associated network application functions 430(1-n), as indicated by the arrows 450(1-n). In the illustrated embodiment, the bootstrapping server function 415 provides the key material (Ks_NAF1, . . . , Ks_NAFn) to the associated network application functions 430(1-n) in response to determining (at 445) the key material (Ks_NAF1, . . . , Ks_NAFn). Accordingly, the network application functions 430(1-n) do not need to request the key material (Ks_NAF1, . . . , Ks_NAFn), e.g. the key material (Ks_NAF1, . . . , Ks_NAFn) may be pushed to the network application functions 430(1-n). In one embodiment, the key material (Ks_NAF1, . . . , Ks_NAFn) is provided to the associated network application functions 430(1-n) at substantially the same time. However, persons of ordinary skill in the art should appreciate that the key material (Ks_NAF1, Ks_NAFn) may be provided to the associated network application functions 430(1-n) in any sequence and with any time delay between provisioning to the network application functions 430(1-n).

Once the key material (Ks_NAF1, . . . , Ks_NAFn) has been provided to the associated network application functions 430(1-n), the user equipment 405 may establish a secure communication link with one or more of the network application functions 430(1-n) using the key material (Ks_NAF1, . . . , Ks_NAFn), as indicated by the arrows 455(1-n). For example, the key material (Ks_NAF1, . . . , Ks_NAFn) stored on the user equipment 405 and the network application functions 430(1-n) should be the same and therefore may be used to mutually authenticate the user equipment 405 and the appropriate network application functions 430(1-n). In some embodiments, root keys for the network application functions 430(1-n) may be stored in servers in the network whose domain name may change or not be known to the user equipment 405. Thus, an operator can provide a user service profile to the bootstrapping server function 415 contains the proper address of the network application functions 430(1-n) that require root keys.

The method 400 may be implemented using hardware, software, or a combination thereof. In one embodiment, the bootstrapping and the root key provisioning software used in the user equipment 405 can be independent of any application specific code. Once the key material (Ks_NAF1, . . . , Ks_NAFn) has been derived, the bootstrapping and/or root key provisioning code may update an appropriate storage area with the new key material. The applications in the user equipment 405 can then use the root keys to secure their respective applications without interfacing or even being aware of the bootstrapping and/or root key provisioning code. New software may also be added to the network application functions 430(1-n) so that they may receive key material from the bootstrapping server function 415 and update a storage area with the new key material. The rest of the software in the network application functions 430(1-n) does not need to be updated, modified, or made aware of the existence of the bootstrapping architecture, such as a Generic Bootstrapping Architecture. Thus, disruptions to the user equipment 405, the network application functions 430(1-n), and/or the existing service caused by adding the bootstrapping and/or root key provisioning code may be reduced.

In contrast, conventional bootstrapping and/or root key provisioning techniques require changes to the existing software in the handset and the NAF to carry an exchange over the Ua interface. Secondly, if the root keys were not provisioned all at once and ahead of their use then user equipment would have to update the root keys when the user equipment needs service from a particular NAF. This would require a service logic change in the user equipment or the NAF to indicate that the root key provisioning process should now start.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of key material generation for authenticating communication with at least one network application function, comprising:
determining first key material in response to a bootstrapping key request;
determining second key material in response to determining said first key material, said second key material corresponding to third key material, said third key material being determined and provided to said at least one network application function in response to determining said first key material.

2. The method of claim 1, comprising providing a request for bootstrapping key provisioning.

3. The method of claim 2, comprising accessing bootstrapping information stored on at least one of a home subscription server, a home location register, and an authentication, authorization and accounting server.

4. The method of claim 3, wherein accessing the bootstrapping information comprises accessing at least one of a user profile, an authentication vector, a key value, a user security setting, an indication of said at least one network application function, and an address of said at least one network application function.

5. The method of claim 3, wherein determining said first key material comprises determining first key material based on the bootstrapping information.

6. The method of claim 2, comprising authenticating a bootstrapping server function using a bootstrapping key generation process.

7. The method of claim 1, wherein determining said second key material comprises determining at least one root key associated with said at least one network application function.

8. The method of claim 7, wherein determining said second key material comprises determining at least one root key based on a key derivation function.

9. The method of claim 7, wherein determining said at least one root key comprises determining at least one root key associated with at least one of an IEEE 802.11 service, a Bluetooth service, a network application service, and a network overlay service.

10. The method of claim 1, comprising forming at least one secure connection with said at least one network application function using said second key material.

11. The method of claim 1, comprising updating said second key material.

12. A method of key material generation for authenticating communication with and at least one network application function, comprising:
determining first key material in response to a bootstrapping key request;
determining second key material in response to determining said first key material, said second key material corresponding to third key material, said third key material being determined by said user equipment in response to determining said first key material; and
providing said second key material to said at least one network application function.

13. The method of claim 12, comprising receiving a request for bootstrapping key provisioning.

14. The method of claim 13, comprising accessing bootstrapping information stored on at least one of a home subscription server, a home location register, and an authentication, authorization and accounting server.

15. The method of claim 14, wherein accessing the bootstrapping information comprises accessing at least one of a user profile, an authentication vector, a key value, a user security setting, an indication of said at least one network application function, and an address of said at least one network application function.

16. The method of claim 14, wherein determining said first key material comprises determining first key material based on the bootstrapping information.

17. The method of claim 13, comprising authenticating said user equipment using a bootstrapping key generation process.

18. The method of claim 12, wherein determining said second key material comprises determining at least one root key associated with said at least one network application function.

19. The method of claim 18, wherein determining said second key material comprises determining at least one root key based on a key derivation function.

20. The method of claim 18, wherein determining said at least one root key comprises determining at least one root key associated with at least one of a WKEY service, a Bluetooth service, and a network overlay service.

21. The method of claim 12, wherein providing said second key material to said at least one network application function comprises said second key material to at least one network application function substantially before at least one secure connection is formed between said user equipment and said at least one network application function using said second key material.

22. The method of claim 12, comprising updating said second key material.
